(19) United States
(12) Patent Application Publication
(10) Pub. No.: US 2009/0018268 A1
(43) Pub. Date: Jan. 15, 2009

(54) Polylactide Acid-Containing Resin Composition, Resin Film and Resin Fiber

(75) Inventor: Aizoh Sakurai, Tokyo (JP)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, St. Paul, MN (US)

(21) Appl. No.: 12/160,462

(22) PCT Filed: Jan. 10, 2007
(86) PCT No.: PCT/US2007/000581

§ 371 Date: Jul. 10, 2008

(30) Foreign Application Priority Data
Jan. 12, 2006 (JP) 2006-004475

(51) Int. Cl. C08L 53/00; C08L 51/00

(52) U.S. Cl. 525/64; 525/92 R

(57) ABSTRACT

A polylactic acid-containing resin composition including a polylactic acid (A), and a (meth)acrylic resin (B) having an alkyl (meth)acrylate constituent unit as a main component, wherein the (meth)acrylic resin (B) having a weight average molecular weight of more than 30,000 g/mole and a glass transition temperature (Tg) of 10° C. or lower, and wherein the polylactic acid (A) and the (meth)acrylic resin (B) form a fine phase separation structure.

### PRIORITY CLAIM

This application claims priority to Japanese Patent Application 2006-004475 filed on Jan. 12, 2006.

### FIELD OF THE INVENTION

This disclosure relates to a polylactic acid-containing resin composition and, more particularly, to a polylactic acid-containing resin composition that has excellent flexibility and elongation characteristics. Also the present invention relates to a polylactic acid-containing resin film or resin fiber formed from the polylactic acid-containing resin composition.

### BACKGROUND

Polylactic acid (PLA) is widely used as a biodegradable plastic material that can be fully degraded. Since polylactic acid is not derived from petroleum, but plants, and is therefore a renewable resource, there is a lot of interest in its use. Furthermore, polylactic acid is also referred to as a carbon circulation type plastic because one of the raw materials utilized in its preparation, lactic acid, is obtained from plants, such as corn and potatoes. After its use, it can be degraded into water and carbon dioxide by biodegradation or incineration.

Polylactic acid is transparent and has a room temperature mechanical strength that is close to that of polyethylene terephthalate as an ester-based plastic material. Polylactic acid also has excellent heat moldability, and therefore its use as a commodity plastic material for daily life should not be surprising. However, since polylactic acid still exhibits performance problems, new industrial uses could be found if heat resistance, brittleness and flexibility are improved.

Other methods have previously been proposed to address the problems discussed above. Such methods attempt to impart flexibility to polylactic acid. Some previous methods have introduced other aliphatic ester components, an ether component or a carbonate component into the skeleton of the polylactic acid by copolymerization to impart flexibility. However, these methods tend to be expensive.

Another proposed method included adding a low molecular weight plasticizer (for example, polyethylene glycol) to the polylactic acid. However, the addition of the plasticizer caused the plasticizer to bleed out (be deposited) on the surface and made the surface sticky.

Another proposed method of solving the problems included adding a polymer having a comparatively low glass transition temperature (Tg) to the polylactic acid. For example, Japanese Unexamined Patent Publication No. 2003-286401 (Kokai) describes a polylactic acid-containing resin composition comprising (a) a polylactic acid and (b) a polymer that contains an unsaturated carboxylic acid alkyl ester-based unit and that has a glass transition temperature of 10° C. or lower. The (b) polymer has a weight average molecular weight of 30,000 g/mole or less. Further, Japanese Unexamined Patent Publication No. 2004-10842 (Kokai) describes a polylactic acid resin composition comprising (a) a polylactic acid and (b) an acrylic acid alkyl ester-based oligomer having a constituent unit represented by formula (III):

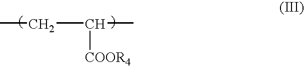

wherein R₄ represents an alkyl group having 1 to 3 carbon atoms. The polylactic acid resin compositions described in the cited applications above are likely to cause bleed out because the acrylic oligomer added to the polylactic acid has a comparatively low molecular weight.

Furthermore when an alkyl acrylate-based oligomer, which has an alkyl group having 4 or more carbon atoms and a low glass transition temperature, is added to the polylactic acid, miscibility between them is lowered. This results in a considerably coarse phase separation structure. Consequently, a homogeneous mixture cannot be obtained and the polymer or oligomer bleeds out. This makes the resulting composition unfit for practical use.

### BRIEF DESCRIPTION OF THE FIGURES

FIG. 1 is an optical micrograph of a polylactic acid-containing resin composition prepared in Comparative Example 3.

FIG. 2 is a transmission electron micrograph of a polylactic acid-containing resin composition prepared in Example 3.

FIG. 3 is a transmission electron micrograph of a polylactic acid-containing resin composition prepared in Example 12.

### SUMMARY OF THE INVENTION

The invention provides a polylactic acid-containing resin composition that has the desired flexibility and elongation characteristics and can suppress bleed out.

The invention also provides a polylactic acid-containing resin film or resin fiber that is transparent and that has desired mechanical properties such as tensile strength, flexibility and elongation characteristics.

The invention provides a polylactic acid-containing resin composition comprising a polylactic acid (A), and a (meth)acrylic resin (B) that contains an alkyl (meth)acrylate constituent unit as a main component, has a weight average molecular weight of more than 30,000 g/mole and has a glass transition temperature (Tg) of 10° C. or lower. The polylactic acid (A) and the (meth)acrylic resin (B) form a fine phase separation structure.

In one embodiment of the invention, the (meth)acrylic resin (B) comprises a (meth)acrylic graft copolymer (B1). In another embodiment of the invention, the polylactic acid-containing resin composition comprises a (meth)acrylic block copolymer (C) of a polylactic acid and a (meth)acrylic polymer, in addition to the polylactic acid (A) and the (meth)acrylic resin (B).

A further embodiment of the invention provides a polylactic acid-containing resin film obtained by forming the polylactic acid-containing resin composition into a sheet.

Yet another embodiment of the invention provides a polylactic acid-containing resin fiber obtained by forming the polylactic acid-containing resin composition of the present invention into a fiber.

### DETAILED DESCRIPTION

The polylactic acid-containing resin composition as well as the polylactic acid-containing resin film and resin fiber of the invention can include many different embodiments. Some of these embodiments will now be described in detail, but the invention is not limited to the following embodiments.

The invention includes a polylactic acid-containing resin composition comprising a polylactic acid (A); and a (meth)acrylic resin (B) that contains an alkyl (meth)acrylate constituent unit as a main component and has a glass transition temperature (Tg) of 10° C. or lower. The (meth)acrylic resin (B) usually has a weight average molecular weight of more than 30,000 g/mole. This embodiment of the polylactic acid-containing resin is referred to hereafter as a first polylactic acid-containing resin composition. This polylactic acid-containing resin composition can be characterized in that the polylactic acid (A) and the (meth)acrylic resin (B) form a fine phase separation structure.

A fine phase separation structure as used herein refers to a so-called “sea-island structure” in which microsomes or fine particulate bodies (islands) of the (meth)acrylic resin (B) are substantially uniformly dispersed in a matrix (sea) of the polylactic acid (A); or a structure in which microsomes (islands) of the polylactic acid (A) are substantially uniformly dispersed in a matrix (sea) of the (meth)acrylic resin (B). The shape of the “microsomes” is not specifically limited, but the microsomes are fine particles having an average particle size of not more than about 50 micrometers (μm) and can be fine particles having an average particle size of about 25 μm or less, and can also have an average particle size of about 10 μm or less, or even about 1 μm or less.

“Average particle size” as used herein is obtained by measuring major diameters, that is, maximum lengths of the respective particles from TEM (transmission electron microscope) micrographs and determining an arithmetic average of the maximum lengths.

The term (meth)acrylate and (meth)acrylic refers to both acrylates and methacrylates.

In general, when an additive, which can cause phase separation, is added to polylactic acid, the additive may cause bleed out. When the polylactic acid and the additive form a fine phase separation structure, however, bleed out can be suppressed.

The polylactic acid (A) used as the first polymer component in the first polylactic acid-containing resin composition of the invention is not specifically limited. The polylactic acid (A) includes poly(L-lactic acid) whose constituent unit is composed only of L-lactic acid, poly(D-lactic acid) whose constituent unit is composed only of D-lactic acid, or poly(D/L-lactic acid) in which a L-lactic acid unit and a D-lactic acid unit exist in various ratios. The polylactic acid that is used can also include copolymers of L- or D-lactic acid with aliphatic hydroxycarboxylic acid other than lactic acid such as, for example, glycolic acid, 3-hydroxybutyric acid, 4-hydroxybutyric acid, 4-hydroxyvaleric acid, 5-hydroxyvaleric acid or 6-hydroxycaproic acid. These polylactic acids may be used alone, or optionally two or more kinds of polylactic acids may be used in combination.

The polylactic acid (A) used in the invention can be prepared by directly dehydropolycondensing L-lactic acid, D-lactic acid or D/L-lactic acid. Alternatively, the polylactic acid can be prepared by subjecting a lactide as a cyclic dimer of lactic acid to ring-opening polymerization. The ring-opening polymerization may be conducted in the presence of a compound having a hydroxyl group, such as a higher alcohol or a hydroxycarboxylic acid. The lactic acid and the other aliphatic hydroxycarboxylic acid copolymer can be prepared by dehydropolycondensing lactic acid with the above hydroxycarboxylic acid. They can also be prepared by subjecting a lactide as a cyclic dimer of lactic acid and a cyclic compound of the above aliphatic hydroxycarboxylic acid to ring-opening polymerization. Exemplary methods of preparing polylactic acid for use in a composition of the invention include the methods described in Japanese Unexamined Patent Publication (Kokai) No. 2003-286401 and Japanese Unexamined Patent Publication (Kokai) No. 2004-10842.

In one embodiment, polylactic acid (A) may include, as a constituent unit, an aliphatic polyester resin containing a lactic acid unit, an aliphatic polyhydric carboxylic acid unit and an aliphatic polyhydric alcohol unit, an aliphatic polyester resin of an aliphatic polyhydric carboxylic acid and an aliphatic polyhydric alcohol, and an aliphatic polyester resin containing a lactic acid unit and polyfunctional polysaccharides. Examples of aliphatic polyhydric carboxylic acid that can be used in the preparation of the resin composition include, but are not limited to, oxalic acid, succinic acid, malonic acid, glutaric acid, adipic acid, pimelic acid, suberic acid, azelaic acid, undecanoic diacid, dodecanoic diacid, and anhydrides thereof. These aliphatic polyhydric carboxylic acids may be acid anhydrides or mixtures with acid anhydrides.

Examples of the aliphatic polyhydric alcohol include, but are not limited to, ethylene glycol, diethylene glycol, triethylene glycol, propylene glycol, dipropylene glycol, 1,3-butanediol, 1,4-butanediol, 3-methyl-1,5-pentanediol, 1,6-hexanediol, 1,9-nonanediol, neopentyl glycol, tetramethylene glycol and 1,4-cyclohexane dimethanol.

The aliphatic polyester resin comprising a lactic acid unit, an aliphatic polyhydric carboxylic acid unit and an aliphatic polyhydric alcohol unit can be prepared by reacting the above aliphatic polyhydric carboxylic acid and the above aliphatic polyhydric alcohol with a copolymer of polylactic acid, lactic acid and the other hydroxycarboxylic acid. Another method includes reacting the above aliphatic polyhydric carboxylic acid and the above aliphatic polyhydric alcohol with lactic acid. Yet another method includes reacting the above aliphatic polyhydric carboxylic acid and the above aliphatic polyhydric alcohol with lactide as a cyclic dimer of lactic acid and cyclic esters of the above hydroxycarboxylic acid. An aliphatic polyester resin of an aliphatic polyhydric carboxylic acid and an aliphatic polyhydric alcohol can be prepared by reacting the above aliphatic polyhydric carboxylic acid with the above aliphatic polyhydric alcohol.

Examples of polyfunctional polysaccharides used in the preparation of an aliphatic polyester resin containing a lactic acid unit and polyfunctional polysaccharides include, but are not limited to, cellulose, cellulose nitrate, cellulose acetate, methyl cellulose, ethyl cellulose, carboxymethyl cellulose, nitrocellulose, cellophane®, regenerated cellulose such as viscose rayon or cupra, hemicellulose, starch, amylopectin, dextrin, dextran, glycogen, pectin, chitin, chitosan, mixtures, and derivatives thereof. Specific examples of polyfunctional polysaccharides that can be utilized include cellulose acetate and ethyl cellulose.

The aliphatic polyester resin containing a lactic acid unit and polyfunctional polysaccharides can be prepared by reacting the above polyfunctional polysaccharides, lactic acid or polylactic acid, and a copolymer of lactic acid and the other hydroxycarboxylic acid. Alternatively, the aliphatic polyester resin can be prepared by reacting the above polyfunctional polysaccharides with lactide as a cyclic dimer of lactic acid or cyclic esters of the above hydroxycarboxylic acid.

In a first polylactic acid-containing resin composition of the invention, various polylactic acids, specifically, various aliphatic polyester resins can be used. In one embodiment, a homopolymer of polylactic acid, a copolymer of lactic acids, a copolymer of lactic acid and an aliphatic hydroxycarboxylic acid other than the lactic acid (when transparency is required, a copolymer containing 50% by weight of a lactic acid component can be utilized) and those containing a lactic acid component such as aliphatic polyester resin comprising lactic acid, an aliphatic polyhydric carboxylic acid and an, aliphatic polyhydric alcohol (when transparency is required, those containing 50% by weight of a lactic acid component) can be used.

The molecular weight of the above-described polylactic acid (A) can vary according to physical properties desired for the particular molded articles that will be formed from the polylactic acid-containing resin composition. When formed into molded articles such as containers, films, sheets and plates, for example, the molecular weight of the polylactic acid used in the invention is not specifically limited as long as sufficient mechanical properties and the above described effects are obtained. When the resulting polylactic acid has a low molecular weight, the strength of the resulting molded article decreases and the decomposition rate increases. On the other hand, when the resulting polylactic acid has a high molecular weight, it becomes difficult to form because the ability to form the composition decreases.

Considering the above, the weight average molecular weight of the polylactic acid used in the invention is within a range of about 10,000 to 5,000,000 g/mole, in one embodiment from about 50,000 to 2,000,000 g/mole, in another embodiment from about 70,000 to 1,000,000 g/mole, and in yet another embodiment from about 90,000 to 500,000 g/mole, in terms of a weight average molecular weight as measured by gel permeation chromatography (GPC). In the particular case of a molded article in the form of a film or sheet, the weight average molecular weight of the polylactic acid is about 10,000 g/mole or more, and in another embodiment about 50,000 g/mole or more. These ranges consider elongation characteristics of the resulting molded article. The upper limit of the weight average molecular weight is not specifically limited as long as the composition can be formed into a film or sheet, but is usually about 2,000,000 g/mole or less. If the composition is to be formed into a molded article in the form of a film or sheet, the weight average molecular weight of the polylactic acid is usually within a range of about 10,000 to 2,000,000 g/mole.

The (meth)acrylic resin (B) used as the second polymer component in the first polylactic acid-containing resin composition of the invention is an acrylic resin that contains an alkyl (meth)acrylate constituent unit as a main component and also has a glass transition temperature (Tg) of 10° C. or lower. In one embodiment, the (meth)acrylic resin (B) is a (meth)acrylic graft copolymer (B1) that is obtained by bonding a molecular main chain containing an alkyl (meth)acrylate as a main component with a polylactic acid having a weight average molecular weight of 2000 g/mole or more, as a graft chain (branched chain), in the form of a branch. The graft chain made of the polylactic acid can play a role in preventing coarsening of a phase separation structure of the polylactic acid (A) and the (meth)acrylic resin (B).

In the (meth)acrylic resin (B), the alkyl (meth)acrylate constituent unit that is the main component can have various ester structures, which can be represented by formula (I).

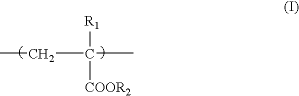

In the above formula, R₁ is a hydrogen atom or a methyl group, and R₂ is an alkyl group having about 1 to 12 carbon atoms in one embodiment and about 1 to 8 carbon atoms in another embodiment. Examples of R₂ include methyl groups, ethyl groups, butyl groups or hexyl groups. The R₂ group may also optionally be substituted with a substituent.

In the formation of (meth)acrylic resin (B), alkyl (meth)acrylates may be used alone, or in combination. The molecular main chain containing this alkyl (meth)acrylate as a main component may be copolymerized with other vinyl monomers. Examples of the vinyl monomers that can be used include, but are not limited to, (meth)acrylic acid, 2-hydroxyethyl (meth)acrylate, glycidyl (meth)acrylate and dimethylaminoethyl (meth)acrylate.

As described above, the (meth)acrylic resin (B) can be used in the form of a (meth)acrylic graft copolymer (B1) that can be obtained by bonding a molecular main chain containing an alkyl (meth)acrylate (also referred to as an acrylic monomer, hereinafter) as a main component with a polylactic acid having a weight average molecular weight of 2000 g/mole or more (also referred to as a PLA macromer, hereinafter), as a graft chain, in the form of a branch. When the weight average molecular weight of the polylactic acid used to form a graft chain is more than 2,000 g/mole, the surface activating function is increased remarkably. This makes it possible to effectively bring out an intrinsic function of the (meth)acrylic resin (B).

In the (meth)acrylic graft copolymer (B1), a ratio of the acrylic monomer to the PLA macromer can vary within a wide range according to the composition or characteristics of the desired graft copolymer. In one embodiment, the ratio of the acrylic monomer to the PLA macromer is within a range from about 99:1 to 50:50 (weight ratio). When the ratio is less than 99:1, dispersability of the resulting graft copolymer in the polylactic acid is lowered and thus coarsening of the phase separation structure can occur. On the other hand, when the ratio is more than 50:50, it becomes difficult to synthesize the graft copolymer.

The (meth)acrylic resin (B), for example, the (meth)acrylic graft copolymer (B1) can be synthesized from the acrylic monomer and the PLA macromer using a usual graft polymerization method. The graft polymerization method is not specifically limited and a simple method includes, for example, a method of preparing a PLA macromer having a (meth)acryloyl group at one end and copolymerizing the PLA macromer with an acrylic monomer (alkyl (meth)acrylate) as a main chain component.

The (meth)acrylic resin (B) can also be synthesized by another method. For example, the acrylic monomer as the main component of the (meth)acrylic resin (B) can be copolymerized with an acrylic monomer such as 2-hydroxyethyl acrylate (HEA) or 2-hydroxyethyl methacrylate (HEMA) thereby to synthesize a (meth)acrylic resin having a hydroxyl group in the side chain. Then, the resulting (meth)acrylic resin can be reacted with organic metals such as Al(Et)₃ and Zn(Et)₂ or metal alkoxides such as Al(OEt)₃, followed by coordinated anionic polymerization with dilactide. Thus, the desired (meth)acrylic resin (B) can be synthesized. Other methods may also be utilized.

The molecular weight of the (meth)acrylic resin (B) can vary according to the kind and weight ratio of the acrylic monomer and the PLA macromer, but the molecular weight (weight average molecular weight as measured by GPC) is generally above about 30,000 g/mole. In one embodiment the weight average molecular weight of the (meth)acrylic resin (B) is within a range from about 50,000 to 2,000,000 g/mole. When the weight average molecular weight of the acrylic resin is 30,000 g/mole or less, the content of an acrylic polymer containing no polylactic acid in the main chain of the acrylic resin increases and it becomes difficult to maintain a fine phase separation structure. On the other hand, when the weight average molecular weight is more than 2,000,000 g/mole, the viscosity of the acrylic polymer increases and it may become difficult to mix the polylactic acid.

The polylactic acid-containing resin composition of the invention can be prepared by mixing the above polylactic acid (A) and the (meth)acrylic resin (B) as well as other components (that will be described in detail hereinafter). The mixing method is not specifically limited and a suitable method can be selected and used considering the amount and properties of the components to be mixed. Examples of methods include a method of mixing using a solvent and a method of mixing by thermofusion.

The above polylactic acid (A) and the (meth)acrylic resin (B) can be mixed in various mixing ratios in the preparation of the polylactic acid-containing resin composition and the mixing ratio is not specifically limited. The mixing ratio of the polylactic acid (A) to the (meth)acrylic resin (B) is generally within a range from about 90:10 to 30:70 (weight mixing ratio). In another embodiment from about 90:10 to 50:50. When the content of the polylactic acid (A) is more than 90 weight %, a molded article, especially a film or a sheet, may become hard or brittle. On the other hand, when the content of the (meth)acrylic resin (B) is more than 70 weight %, the formed film or sheet can be too soft and the tensile strength may decrease. Therefore, the particular ratios are generally based on the particular use that the article may have.

In the first polylactic acid-containing resin composition, (meth)acrylic resin (B) is the above-described (meth)acrylic graft copolymer (B1). A (meth)acrylic homopolymer (B2) may be used in combination with the (meth)acrylic graft copolymer (B1).

In addition to the first polylactic acid-containing resin composition, a second polylactic acid-containing resin composition is provided that comprises a polylactic acid (A), a (meth)acryl resin (B) that contains an alkyl (meth)acrylate constituent unit as a main component and also has a glass transition temperature (Tg) of 10° C. or lower, and a (meth)acrylic block copolymer (C) of a polylactic acid and a (meth)acrylic polymer. In this polylactic acid-containing resin composition, the (meth)acrylic block copolymer (C) used as a third polymer component contributes to the stability of the fine phase separation structure of the polylactic acid (A) and the (meth)acrylic resin (B); and also functions to prevent the (meth)acrylic resin (B) from being exuded from the polylactic acid-containing resin composition.

In the second polylactic acid-containing resin composition, the polylactic acid (A) as the first polymer component is the same as or substantially the same as the polylactic acid (PLA) used in the above-described first polylactic acid-containing resin composition. Therefore, detailed description of the polylactic acid (A) is omitted here.

The (meth)acrylic resin (B) as the second polymer component can basically form a fine phase separation structure of the polylactic acid (A), similar to the (meth)acrylic resin in the first polylactic acid-containing resin composition, and thus the (meth)acrylic resin (B) is substantially uniformly dispersed in the polylactic acid (A). The (meth)acrylic resin (B) is generally a microsome having an average particle size of about 50 μm or less, in another embodiment 25 μm or less, in yet another embodiment 1 μm or less; and has a weight average molecular weight of above 30,000 g/mole.

The (meth)acrylic resin (B) can be various (meth)acrylic resins as described above and is generally a (meth)acrylic homopolymer containing, as a main component, an alkyl (meth)acrylate constituent unit represented by the following formula (II):

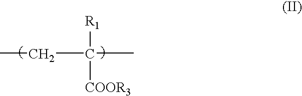

wherein R₁ represents a hydrogen atom or a methyl group, and R₃ represents an alkyl group having about 2 to 12 carbon atom in some embodiments or about 2 to 8 carbon atoms in another embodiment. Any of these alkyl R₃ groups may optionally be substituted with a substituent. In some exemplary (meth)acrylic resins (B), the R₃ group is a methyl group, an ethyl group, a butyl group or a hexyl group. The (meth)acrylic homopolymer can be prepared by a conventional polymerization method in the same manner as described above for the (meth)acrylic graft copolymer (B1).

The (meth)acrylic block copolymer (C) includes various block copolymers of polylactic acid and poly(meth)acrylate. The polylactic acid in the (meth)acrylic block copolymer can be the same as the above polylactic acid (A) (PLA) as well as other types of polylactic acid. The (meth)acrylic polymer is any polymer derived from the above alkyl (meth)acrylate or the other (meth)acrylic monomer.

The (meth)acrylic block copolymer (C) can be synthesized from the polylactic acid and the (meth)acrylic polymer using conventional block polymerization methods. The block polymerization method is not specifically limited. According to one simple method, (meth)acrylic block copolymer (C) can be synthesized, for example, by preparing a polylactic acid (also referred to as a macro-initiator, a macromer that functions as an initiator) whose one end is modified with a halogen having radical initiation ability, and initiating radical polymerization of an acrylic monomer from the macro-initiator. This polymerization method is known as an ATRP method.

The (meth)acrylic block copolymer (C) can also be synthesized by other methods. For example, a (meth)acrylic resin having a hydroxyl group at the end can be synthesized using a radical polymerization initiator. Next, the resulting (meth)acrylic resin can be reacted with an equimolar amount (0.5 equivalents in terms of a functional group) of a difunctional isocyanate and then reacted with an equimolar amount of a polylactic acid. Thus, the desired (meth)acrylic block copolymer (C) can be synthesized.

Alternatively, the (meth)acrylic block copolymer (C) can also be synthesized by synthesizing the (meth)acrylic resin having a hydroxyl group at the end in the same manner as above. The resulting (meth)acrylic resin can be reacted with organic metals such as Al(Et)₃ or Zn(Et)₂ or metal alkoxides such as Al(OEt)₃, followed by coordinated anionic polymerization with dilactide. Other methods may also be utilized.

The molecular weight of the (meth)acrylic block copolymer (C) can vary according to the kind and weight ratio of the polylactic acid and the acrylic monomer, but the molecular weight (weight average molecular weight as measured by GPC) is generally about 4,000 g/mole or more. In one embodiment the weight average molecular weight of the block copolymer (C) is within a range from about 8,000 to 2,000,000 g/mole. When the weight average molecular weight of the block copolymer (C) is less than 4,000, it can become difficult to maintain a fine phase separation structure. On the other hand, when the weight average molecular weight is more than 2,000,000 g/mole, viscosity increases and it may become difficult to mix with the polylactic acid (A).

The form of (meth)acrylic block copolymer (C) that is utilized is not limited as long as an adverse influence is not exerted on its ability to function as a compatibilizing agent. The block copolymer (C) may be liquid or solid.

The second polylactic acid-containing resin composition of the invention can be prepared by mixing the polylactic acid (A), the (meth)acrylic resin (B) and the (meth)acrylic block copolymer (C) as well as other components (that will be described in detail hereinafter). The mixing method is generally not limited and a method can be selected and used by considering the amount and properties of the components to be mixed. Examples of possible methods include a method of mixing using a solvent and a method of mixing by thermofusion.

In the second polylactic acid-containing resin composition, the polylactic acid (A) and the (meth)acrylic resin (B) can be mixed in various mixing ratios, similar to the preparation of the first polylactic acid-containing resin composition. The mixing ratio of the polylactic acid (A) to the (meth)acrylic resin (B) is generally within a range from about 90:10 to 60:40 (weight mixing ratio), and in another embodiment from about 90:10 to 50:50. When the content of the polylactic acid (A) is more than 90 weight %, a formed film or sheet may become hard or brittle, which is generally to be avoided. On the other hand, when the content of the (meth)acrylic resin (B) is more than 40 weight %, it may become impossible to prevent the (meth)acrylic resin (B) from being exuded from the polylactic acid-containing resin composition.

Similar to the polylactic acid (A) and the (meth)acrylic resin (B), the (meth)acrylic block copolymer (C) can be mixed in various amounts. Generally, the amount of the block copolymer (C) is defined in connection with the polylactic acid (A) and the (meth)acrylic resin (B). The mass mixing ratio of the block copolymer (C) to the total mass of the polylactic acid (A) and the (meth)acrylic resin (B) is generally within a range from about 100:0.1 to 100:10, and in another embodiment from about 100:0.1 to 100:5. When the content of the block copolymer (C) is less than 0.1 part relative to 100 parts of the combined amount of the polylactic acid (A) and the (meth)acrylic resin (B), the addition effect of the block copolymer (C) as a compatibilizing agent decreases. On the other hand, when the content of the block copolymer (C) is more than 10 parts relative to 100 parts of the combined amount of the polylactic acid (A) and the (meth)acrylic resin (B), the addition effect of the block copolymer (C) as a compatibilizing agent is not enhanced.

The polylactic acid-containing resin composition of the present invention can optionally contain one or more additives, in addition to the polylactic acid (A) and the (meth)acrylic resin (B) for the first polylactic acid-containing resin composition or the polylactic acid (A), the (meth)acrylic resin (B) and the (meth)acrylic block copolymer (C) for the second polylactic acid-containing resin composition. Examples of additives that can be incorporated into the polylactic acid-containing resin composition include, but are not limited to, fillers, pigments, nucleating agents, antioxidants, thermal stabilizers, photostabilizers, antistatic agents, blowing agents and flame retardants. Specific examples of these additives include fillers such as calcium carbonate, clay, carbon black and impact-resistant core/shell type particles; and pigments such as titanium oxide, metallic pigment and pearlescent pigment. These additives can be incorporated in any amount as long as the characteristics of the composition or articles are not affected.

The polylactic acid-containing resin composition of the invention can be formed into articles having various forms. For example, a molded article can be produced by mixing the polylactic acid (A) and the (meth)acrylic resin (B) and, optionally, the (meth)acrylic block copolymer (C) and additives in predetermined amounts; dissolving these raw materials in a solvent; mixing the resulting solution or melt-kneading raw materials to obtain a polylactic acid-containing resin composition with a predetermined composition; and forming the resin composition. The resin composition can be formed by, for example, an injection molding method, an extrusion blow molding method, an extrusion drawing blow molding method, an injection blow molding method, an injection drawing blow molding method, a biaxial drawing method, a thermomolding method or a compression molding method. Also film-, sheet- and plate-like molded articles can be produced by an inflation molding method or a T-die molding method. According to another method, a polylactic acid-containing fiber can also be produced by forming the polylactic acid-containing resin composition into a fiber.

In the invention, a molded article can be advantageously provided in the form of a film or a sheet. As used herein, film and sheet have the same meaning and refer to thin-wall rectangular or similar articles derived from a polylactic acid-containing resin composition of the invention in a thickness ranging from about 5 μm to about 3 mm. The resin film of the present invention or resin sheet (hereinafter referred to as a “resin film”) may have a thickness that is more or less than the above range, if necessary. The resin film may have a single-layered structure or a multi-layered structure composed of two or more layers.

A resin film of the present invention can be advantageously produced by melt-kneading a polylactic acid (A) and a (meth)acrylic resin (B) and, optionally, a (meth)acrylic block copolymer (C) in the presence or absence of the additive described above, and forming the resulting melt-kneaded mixture into a film by any molding method. The melt-kneading method is economically and environmentally advantageous. Conventionally known kneading methods that can be utilized include, but are not limited to, a method of mixing raw materials using a twin-screw kneader, a Henshel mixer or a ribbon blender in a solid state. The temperature upon melt-kneading can vary widely, but is usually about 160° C. or higher. Next, the resulting melt-kneaded mixture is formed into a film. The molding method used herein is not limited, but can be, for example, a T-die molding method, a blow molding method or an inflation molding method. As explained above, the resulting resin film can be used for various purposes as a base material with excellent flexibility and elongation characteristics.

The resin film of the invention can also be produced by a solution cast method in place of the above discussed melt-kneading method. The solution cast method can be carried out by dissolving a polylactic acid (A) and a (meth)acrylic resin (B) and, optionally, a block copolymer (C) and an additive in a suitable solvent, and casting the resulting resin solution on a suitable base material, followed by drying in accordance with the same procedure as is normally used in case of molding a film.

The addition of the (meth)acrylic resin (B) as a second polymer component to the polylactic acid (A) (as the first polymer component) provides a polylactic acid-containing composition that has excellent flexibility and elongation characteristics without adversely affecting characteristics that are intrinsic to the polylactic acid such as transparency and mechanical properties such as tensile strength and heat moldability. It is thought, but not relied upon, that the (meth)acrylic resin (B) improves flexibility and elongation characteristics and also does not migrate from the resin composition, and thus makes it possible to suppress the occurrence of bleed out. While polylactic acid-containing resin compositions of the invention have a phase separation structure in which the (meth)acrylic resin (B) is dispersed in the polylactic acid (A), as the (meth)acrylic resin (B) comprises a (meth)acrylic graft copolymer (B1) or the resin composition further comprises a (meth)acrylic block copolymer (C), the resin composition can maintain the resulting fine phase separation structure, thereby maintaining the flexibility and the inhibition of bleed out.

Further, according to the invention, by using the polylactic acid-containing resin composition of the invention as a raw material, it is possible to provide a renewable resin film or resin fiber containing, as a main component, a component derived from plants, which has excellent transparency and mechanical properties such as tensile strength, flexibility and elongation characteristics.

The use of conventional polylactic acid-containing resin films is generally limited to purposes such as packaging materials (e.g. food) that do not require flexibility. However, the resin films of the invention have excellent flexibility and elongation characteristics and can therefore advantageously be used for various purposes that require three-dimensional conformability. For example, the polylactic acid-containing resin film of the present invention can be used as wall materials and decorative films by using it as a base material, forming an adhesive layer on one surface of the base material and optionally forming any layer such as a printing layer or top coat layer on the other surface.

### EXAMPLES

The invention will now be described by way of examples thereof. The invention is not limited by and is only exemplified by the following examples.

### Materials

In the examples and comparative examples, the following polymers were used as starting materials to prepare polylactic acid-containing resin compositions.

### Polymer (a):

PLA (polylactic acid), weight average molecular weight equal to 140,000 g/mole, LACEA® H-100, manufactured by Mitsui Chemicals; dried in a vacuum oven at 60° C. for 24 or more hours before use.

### Polymer (b):

Poly-nBA (poly n-butyl acrylate), weight average molecular weight equal to 400,000 g/mole; after solution polymerization of an n-butyl acrylate monomer, the resulting product was coated in the form of a sheet and then the solvent was removed.

### Polymer (c):

Poly-nBA-g-PLA (poly n-butyl acrylate-g-polylactic acid), weight average molecular weight equal to 300,000 g/mole; after solution polymerization of an n-butyl acrylate monomer and a polylactic acid macromer, the resulting product was coated in the form of a sheet and then the solvent was removed. A charge weight ratio of n-butyl acrylate:polylactic acid macromer was 80:20. The polylactic acid macromer used was prepared in Preparation Example 1 described hereinafter.

### Polymer (d):

PLA-b-poly-EA (polylactic acid-b-polyethyl acrylate), weight average molecular weight equal to 120,000 g/mole; using a polylactic acid macro-initiator prepared in Preparation Example 2, radical polymerization of an ethyl acrylate monomer was conducted and, after coating in the form of a sheet, the solvent was removed. With respect to details of the preparation method, please refer to Preparation Example 3 described hereinafter.

### Preparation Example 1

### Preparation of Polylactic Acid Macromer

In a 200 ml two-necked nitrogen-evacuated flask, 5.0 g of polylactic acid (LACEA H-100) was charged and 100 ml of previously dried 1,4-dioxane was added to dissolve the polylactic acid. Subsequently, 1 ml of previously distilled triethylamine and 1 ml of acrylic acid chloride were charged in the two-necked flask, followed by stirring at room temperature for 6 hours. One ml of ethanol was added and, the solution was stirred for 5 minutes. The resulting reaction solution was added drop wise to 500 ml of methanol to precipitate a polylactic acid macromer. The precipitated polylactic acid macromer was recovered, purified twice by reprecipitation and then dried in a vacuum oven for 8 hours to obtain 4.25 g of a polylactic acid macromer. A standard polystyrene equivalent molecular weight of the resulting polylactic acid macromer was measured by gel permeation chromatography (GPC) and was 150,000 g/mole.

### Preparation Example 2

### Preparation of Polylactic Acid Macro-Initiator

In a 200 ml two-necked nitrogen-evacuated flask, 5.0 g of polylactic acid (LACEA H-100) was charged and 100 ml of previously dried 1,4-dioxane was added to dissolve the polylactic acid. Subsequently, 1 ml of previously distilled triethylamine and an excess amount (1 ml) of 2-bromopropionyl bromide were charged in the two-necked flask, followed by stirring at room temperature for 6 hours. One ml of ethanol was added and, the solution was stirred for 5 minutes. The resulting reaction solution was added drop wise to 500 ml of methanol to precipitate a polylactic acid macro-initiator. The precipitated polylactic acid macro-initiator was recovered, purified twice by reprecipitation, and then dried in a vacuum oven for 8 hours to obtain 4.25 g of a polylactic acid macro-initiator. With respect to the resulting polylactic acid macro-initiator, a standard polystyrene equivalent molecular weight was measured by GPC and was 150,000 g/mole.

### Preparation Example 3

### Preparation of Polymer (d): PLA-b-poly-EA

In a 100 ml single-necked Kjeldahl flask, 1.0 g of the polylactic acid macro-initiator prepared in Preparation Example 2 and 29 mg of cuprous bromide were charged. 10.0 g of a previously alumina-filtered ethyl acrylate monomer and 10.0 g of previously alumina-filtered 1,4-dioxane were added in the flask, and then dissolved under reduced pressure. After the atmosphere in the flask was returned to a nitrogen gas atmosphere, 69 mg of N,N,N′,N″,N″-pentamethyldiethylenetriamine (PMDETA) was added, followed by stirring at room temperature under reduced pressure for 30 minutes. After the atmosphere in the flask was returned again to a nitrogen gas atmosphere, 1.0 g of methanol was added. After the flask was evacuated, radical polymerization was conducted at 60° C. for 66 hours. The reaction solution was cooled in a refrigerator and filtered through an ion-exchange resin (manufactured by The Dow Chemical Company under the trade name of “DOWEX MSC-1”), followed by stirring for 30 minutes. The reaction solution was filtered through an alumina column and the filtrate was dried under reduced pressure to obtain 1.70 g of a product. It was confirmed that the product is an objective PLA-b-p-nEA. With respect to the resulting PLA-b-poly-EA, a standard polystyrene equivalent molecular weight was measured by GPC and was 120,000 g/mole.

### Measurement of Physical Properties and Evaluation Test

To evaluate polylactic acid-containing resin compositions and resin films in the examples and comparative examples, the measurement of glass transition temperature (Tg), Young's modulus, the measurement of an upper yield stress and elongation at break (due to tensile test), and an exudation test were carried out by the following procedures.

### Measurement of Glass Transition Temperature (Tg)

With respect to a polylactic acid-containing resin composition after mixing, a glass transition temperature (Tg) was measured by using a differential scanning calorimeter (manufactured by Seiko Electronic Industry under the trade name of “EXSTAR 6000”). Tg is measured for the purpose of judging whether or not phase separation occurred in the polylactic acid-containing resin composition. If Tg is observed at two points in a plotted Tg curve, it is confirmed that phase separation occurred.

### Measuring Procedure:

The measurements were taken under the flow of nitrogen gas. To eliminate heat history of a sample, the temperature of the sample was raised from room temperature to 200° C. (temperature raising rate: 10° C./min) and was maintained for 5 minutes. The temperature was then decreased from 200° C. to the temperature that is sufficiently lower than Tg of the sample (−60° C. to −80° C.) at 20° C./min and was maintained for 10 minutes. At this time, it was confirmed that the polylactic acid-containing resin composition was not crystallized and the temperature was raised to 250° C. at 10° C./min. The glass transition temperature was measured.

### Tensile Test

With respect to the resin film thus obtained, tensile elastic modulus (Young's modulus), upper yield stress and elongation at break were measured by a tensile testing machine (Model: Tensilon RTC-1325A, manufactured by ORIENTEC Co., Ltd.).

A strip-shaped sample of 30 mm in length×5 mm in width×about 100 Mm in thickness was utilized

Measuring conditions: The testing was conducted at 300 mm/min with the distance between chucks being 20 mm. The temperature during the test was room temperature, about 25° C.

With respect to each sample, the measurement was conducted three times and an average value was determined.

### Exudation Test

This test was conducted to determine whether or not an acrylic resin (B) was exuded from a polylactic acid-containing resin composition. Exudation of the acrylic resin (B) was confirmed by examining whether or not the resulting resin film (sample) was sticky when it was picked up with fingers. No stickiness meant that the acrylic resin (B) did not exude.

### Comparative Example 1

In this example, a resin film made of a polylactic acid alone was produced and tested for comparison.

As described in Table 1, only polymer (a) (polylactic acid resin (LACEA H-100)) was used as a raw material. The polymer (a) was dissolved in chloroform to prepare a 5% by weight polymer solution. The resulting polymer solution was cast, kept at a room temperature for 24 hours and then dried in a vacuum oven at 50° C. for 8 hours to obtain a resin film having a thickness of about 100 μm.

Strip-shaped samples were made from the resulting resin film and then Young's modulus, upper yield stress and elongation at break were measured by the above procedures. The results of those measurements are described in Table 2.

### Comparative Examples 2 and 3

The procedure described in Comparative Example 1 was repeated, except that combinations of polymer (a) and polymer (b) were used in place of the polymer (a), as described in Table 1 below and resin films were produced and tested.

Strip-shaped samples were made from the resulting resin films and then Young's modulus, upper yield stress and elongation at break were measured by the above procedures. The results of those measurements are described in Table 2.

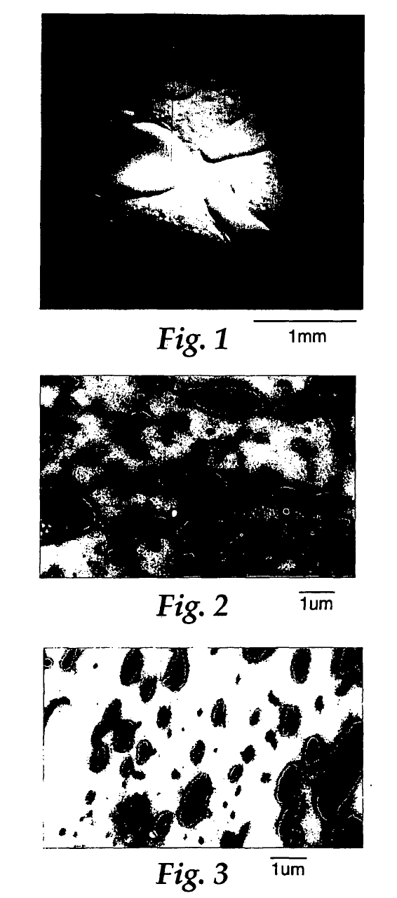

The polylactic acid-containing resin composition prepared in Comparative Example 3 was observed by an optical microscope and a transmission electron microscope (TEM). This inspection showed that the acrylic resin (B) was contained as a continuous body having a size in the millimeter range and the resin composition was not in a substantially uniform state and did not constitute a fine phase separation structure (optical micrograph shown in FIG. 1).

### Examples 1 to 12

The procedure described in Comparative Example 1 was repeated, except that combinations of polymer (a), polymer (b), polymer (c) and polymer (d) were used in place of the polymer (a), as described in Table 1 below, and resin films were produced and tested.

Strip-shaped samples were made from the resulting resin film and then Young's modulus, upper yield stress and elongation at break were measured by the above procedures. The results of those measurements are described in Table 2.

With respect to Examples 2 and 3, the glass transition temperature (Tg) was also measured to obtain the following results: Example 2 equal to −48.0/56.0° C., and Example 3 equal to −51.5/56.5° C. In the respective examples, the glass transition temperature was observed at two points. Thus, it is apparent that the polylactic acid and the acrylic resin cause phase separation.

Furthermore, the polylactic acid-containing resin composition prepared in Example 3 was observed by a transmission electron microscope (TEM). As a result, it was confirmed that a fine phase separation structure in which microsomes of the acrylic resin (B) are dispersed in the polylactic acid (A) was formed (see TEM micrograph shown in FIG. 2). The number of particles having different particle sizes (major diameters) was counted using the TEM micrograph to obtain the following results.

| | | | |
|---|---|---|---|
| <100 | nm | 113 | particles |
| 100 to 200 | nm | 36 | particles |
| 200 to 500 | nm | 23 | particles |
| 500 to 1000 | nm | 2 | particles |
| 1000 to 1500 | nm | 3 | particles |
| 1500 to 2000 | nm | 1 | particle |

The average particle size was found to be 216 nm.

In the same manner, the polylactic acid-containing resin composition prepared in Example 12 was observed by a transmission electron microscope (TEM). As a result, it was confirmed that a fine phase separation structure in which microsomes of the acrylic resin (B) were dispersed in the polylactic acid (A) was formed (see TEM micrograph shown in FIG. 3). The number of particles having different particle sizes (major diameters) was counted using the TEM micrograph to obtain the following results.

| | | | |
|---|---|---|---|
| <100 | nm | 19 | particles |
| 100 to 200 | nm | 24 | particles |
| 200 to 500 | nm | 15 | particles |
| 500 to 1000 | nm | 14 | particles |
| 1000 to 1500 | nm | 1 | particle |
| 1500 to 2000 | nm | 2 | particles |

The average particle size was found to be 449 nm.

TABLE 1

| | | Acrylic | | Block copolymer |
|---|---|---|---|---|
| | Polylactic | resin (B) | | (C) |
| | acid (A) | Polymer | Polymer (c) | Polymer (d) |
| | Polymer (a) | (b) | poly-BA- | PLA-b- |
| Example No. | PLA | poly-BA | g-PLA | poly-EA |
| Comparative | 100 | | | |
| Example 1 | | | | |
| Comparative | 75 | 25 | | |
| Example 2 | | | | |
| Comparative | 70 | 30 | | |
| Example 3 | | | | |
| Example 1 | 90 | | 10 | |
| Example 2 | 80 | | 20 | |
| Example 3 | 70 | | 30 | |
| Example 4 | 60 | | 40 | |
| Example 5 | 50 | | 50 | |
| Example 6 | 40 | | 60 | |
| Example 7 | 30 | | 70 | |
| Example 8 | 70 | 30 | 5 | |
| Example 9 | 70 | 15 | 15 | |
| Example 10 | 90 | 10 | | 5 |
| Example 11 | 75 | 25 | | 5 |
| Example 12 | 70 | 30 | | 5 |

TABLE 2

| | Young's | Upper yield | Elongation at | |
|---|---|---|---|---|
| | modulus | point | break | Exudation test |
| Example No. | E × 10⁹ (Pa) | (MPa) | (%) | (Stickiness) |
| Comparative | 1.15 | 63.9 | 18 | no |
| Example 1 | | | | |
| Comparative | 0.71 | 29.2 | 32 | yes |
| Example 2 | | | | |
| Comparative | 0.48 | 24.2 | 80 | yes |
| Example 3 | | | | |
| Example 1 | 0.89 | 43.5 | 290 | no |
| Example 2 | 0.84 | 37.9 | 136 | no |
| Example 3 | 0.64 | 26.6 | 140 | no |
| Example 4 | 0.68 | 25.8 | 125 | no |
| Example 5 | 0.60 | 23.1 | 245 | no |
| Example 6 | 0.37 | 14.1 | 72 | no |
| Example 7 | 0.31 | 13.4 | 39 | no |
| Example 8 | 0.51 | 20.9 | 68 | no |
| Example 9 | 0.49 | 21.5 | 121 | no |
| Example 10 | 0.82 | 37.1 | 219 | no |
| Example 11 | 0.66 | 26.8 | 42 | no |
| Example 12 | 0.60 | 24.2 | 69 | no |

As is apparent from the measurement results shown in Table 2, the polylactic acid-containing resin compositions prepared by mixing a polylactic acid [polymer (a)] with an acrylic resin [polymer (b), polymer (c) or polymer (d)] (Comparative Examples 2 and 3, Examples 1 to 12), had excellent Young's modulus, upper yield stress and elongation at break in comparison with the films made using the polylactic acid alone (Comparative Example 1). This shows that excellent flexibility was imparted to the resulting resin film.

In the polylactic acid-containing resin compositions prepared by mixing a polylactic acid [polymer (a)] with an acrylic resin [polymer (c)] (Examples 1 to 9), the acrylic resin did not exude on the surface of the resin film. The same was found for the polylactic acid-containing resin compositions prepared by mixing a polylactic acid [polymer (a)] with an acrylic resin [polymer (b) and polymer (d)] (Examples 10 to 12).

To the contrary, in the polylactic acid-containing resin compositions (Comparative Examples 2 and 3) prepared by mixing acrylic resin [polymer (b)] in which the polylactic acid is not grafted, the acrylic resin was deposited on the surface due to a large phase separation structure, and thus the resulting compositions were not fit for practical use.

As is apparent from the measurement results of the glass transition temperature, although the polylactic acid and the acrylic resin cause phase separation, the polylactic acid-containing resin composition of this example exhibits excellent flexibility and causes no exudation of the acrylic resin because this phase separation structure is a very fine structure as shown in the micrographs of FIG. 2 and FIG. 3.

1. A polylactic acid-containing resin composition comprising:
a polylactic acid (A); and
a (meth)acrylic resin (B) having an alkyl (meth)acrylate constituent unit as a main component, wherein said (meth)acrylic resin (B) comprises a (meth)acrylic graft copolymer (B1) having a weight average molecular weight of more than 30,000 g/mole and a glass transition temperature (Tg) of 10° C. or lower, and
wherein the polylactic acid (A) and the (meth)acrylic resin (B) form a fine phase separation structure.

2. A polylactic acid-containing resin composition comprising:
a polylactic acid (A);
a (meth)acrylic resin (B) having an alkyl (meth)acrylate constituent unit as a main component wherein said (meth)acrylic resin (B) has a weight average molecular weight of more than 30,000 g/mole and a glass transition temperature (Tg) of 10° C. or lower; and
a (meth)acrylic block copolymer (C),
and wherein the polylactic acid (A) and the (meth)acrylic resin (B) form a fine phase separation structure.

3. The polylactic acid-containing resin composition according to claim 1, wherein the (meth)acrylic resin (B) is a microsome having an average particle size of 50 μm or less.

4. The polylactic acid-containing resin composition according to claim 1, wherein the polylactic acid (A) and the (meth)acrylic resin (B) have a weight ratio from 90:10 to 50:50.

5. The polylactic acid-containing resin composition according to claim 1, wherein the alkyl (meth)acrylate constituent unit is represented by formula (I): 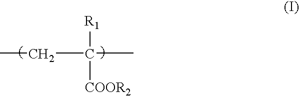
wherein R₁ represents a hydrogen atom or a methyl group and R₂ represents an alkyl group having from 1 to 12 carbon atoms.

6. The polylactic acid-containing resin composition according to claim 1, wherein the (meth)acrylic graft copolymer (B1) is a (meth)acrylic graft copolymer obtained by bonding a molecular main chain containing an alkyl (meth)acrylate as a main component with a polylactic acid having a weight average molecular weight of 2000 g/mole or more in the form of a branch.

7. The polylactic acid-containing resin composition according to claim 2, wherein a mass mixing ratio of the mass of the (meth)acrylic block copolymer (C) to the total mass of the polylactic acid (A) and the (meth)acrylic resin (B) ranges from 100:0.1 to 100:10.

8. A polylactic acid-containing resin film obtained by forming the polylactic acid-containing resin composition according to claim 1 into a sheet.

9. A polylactic acid-containing resin fiber obtained by forming the polylactic acid-containing resin composition according to claim 1 into a fiber.

10. The polylactic acid-containing resin composition according to claim 2, wherein the (meth)acrylic resin (B) is a microsome having an average particle size of 50 μm or less.

11. The polylactic acid-containing resin composition according to claim 2, wherein the polylactic acid (A) and the (meth)acrylic resin (B) have a weight ratio from 90:10 to 50:50.

12. The polylactic acid-containing resin composition according to claim 2, wherein the alkyl (meth)acrylate constituent unit is represented by formula (I): 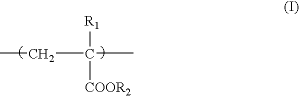
wherein R₁ represents a hydrogen atom or a methyl group and R₂ represents an alkyl group having from 1 to 12 carbon atoms.

13. A polylactic acid-containing resin film obtained by forming the polylactic acid-containing resin composition according to claim 2 into a sheet.

14. A polylactic acid-containing resin fiber obtained by forming the polylactic acid-containing resin composition according to claim 2 into a fiber.
